(19) United States
(12) Patent Application Publication
(10) Pub. No.: US 2016/0086690 A1
(43) Pub. Date: Mar. 24, 2016

(54) Cable Beam and Method of Manufacturing the Same

(71) Applicant: Raychem Electronics (Shanghai) Ltd., Shanghai (CN)

(72) Inventors: Tao Guo, Shanghai (CN); Wei Zhen, Shanghai (CN); Jianyong Liu, Shanghai (CN)

(73) Assignee: RAYCHEM ELECTRONICS (SHANGHAI) LTD., Shanghai (CN)

(21) Appl. No.: 14/858,298

(22) Filed: Sep. 18, 2015

(30) Foreign Application Priority Data
Sep. 18, 2014 (CN) 201410478028.6

(51) Int. Cl. H01B 7/00; H01B 13/00; H01B 13/14

(52) U.S. Cl. CPC H01B 7/0045; H01B 13/14; H01B 13/0036

(57) ABSTRACT

A cable beam is provided and includes a first cable and a second cable. The first cable includes a first conductor and a first PTC material layer clad on the first conductor. The second cable includes a second conductor and a second PTC material layer clad on the second conductor. The second cable is wound with the first cable and the first PTC material layer is electrically connected to the second PTC material layer.

### CROSS-REFERENCE TO RELATED APPLICATIONS

This application claims the benefit of the filing date under 35 U.S.C. §119(a)-(d) of Chinese Patent Application No. 201410478028.6 filed on Sep. 18, 2014.

### FIELD OF THE INVENTION

The invention relates to a cable and, more particularly, a cable for a circuit protection device.

### BACKGROUND

Positive temperature coefficient (PTC) circuit protection devices are well-known in the art. They are typically independent electronic devices that provide over current protection and/or over voltage protection. However, they cannot be used in place of a cable to transmit electric power. Therefore, in the prior art, it is necessary to use a cable that is independent of the PTC circuit protection device to transmit the electric power among various electrical equipment.

In the prior art, a known PTC circuit protection device may be mounted on a circuit board or connected between cables. It is necessary to reserve space for installation of the PTC circuit protection device and a large number of cables that are arranged in very high dense area. In this case, installation space becomes very tight and it is difficult to install many independent PTC circuit protection devices. At the same time, since a main body of the PTC circuit protection device has certain rigidity, the cable cannot be bent at the location of the PTC circuit protection device when the PTC circuit protection device is connected between the cables, reducing the cable layout density.

### SUMMARY

The invention has been made to overcome or alleviate at least one aspect of the above mentioned disadvantages. Accordingly, a cable beam is provided and includes a first cable and a second cable. The first cable includes a first conductor and a first PTC material layer clad on the first conductor. The second cable includes a second conductor and a second PTC material layer clad on the second conductor. The second cable is wound with the first cable and the first PTC material layer is electrically connected to the second PTC material layer.

### BRIEF DESCRIPTION OF THE DRAWINGS

The above and other features of the invention will become more apparent by describing in detail exemplary embodiments thereof with reference to the accompanying drawings, in which:

FIG. 1 is a longitudinal cross-section view of two cables for a cable beam according to the invention;

FIG. 2 is a perspective view of a cable beam according to the invention;

FIG. 3 is a perspective view of a cable beam of FIG. 2 showing an outer insulation layer provided on an outer surface thereof;

FIG. 4 is a longitudinal cross-section view of another cable beam according to the invention;

FIG. 5 is a perspective view of the cable beam of FIG. 4 showing a cable and a bare wire wound with each other; and

FIG. 6 is a perspective view of a cable beam of FIG. 5 showing an outer insulation layer provided on an outer surface thereof.

### DETAILED DESCRIPTION OF THE EMBODIMENT(S)

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

With reference to FIGS. 1 through 3, a cable beam according to the invention is illustrated. As shown in FIGS. 1 through 3, in an exemplary embodiment of the invention, the cable beam generally includes a first cable 10 and a second cable 20 that are then wound with each other. Furthermore, an outer insulation layer 30 is provided on the wound first cable 10 and the second cable 20.

As clearly shown in FIG. 1, the first cable 10 includes a first conductor 11 and a first PTC (Positive Temperature Coefficient) material layer 12 clad on the first conductor 11. The second cable 20 includes a second conductor 21 and a second PTC material layer 22 clad on the second conductor 21.

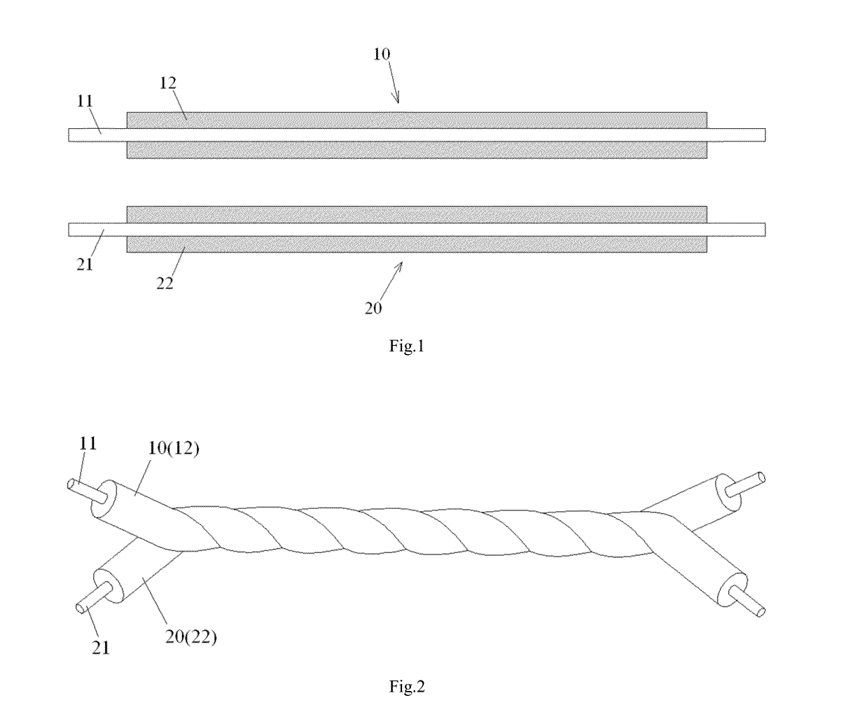

In an embodiment of the invention, as clearly shown in FIG. 2, the first cable 10 and the second cable 20 are wound with each other, so that the first PTC material layer 12 electrically contacts the second PTC material layer 22 and that an electrical current can flow from the first conductors 11, 21 to the second conductors 11, 21 through the first and second PTC material layers 12, 22.

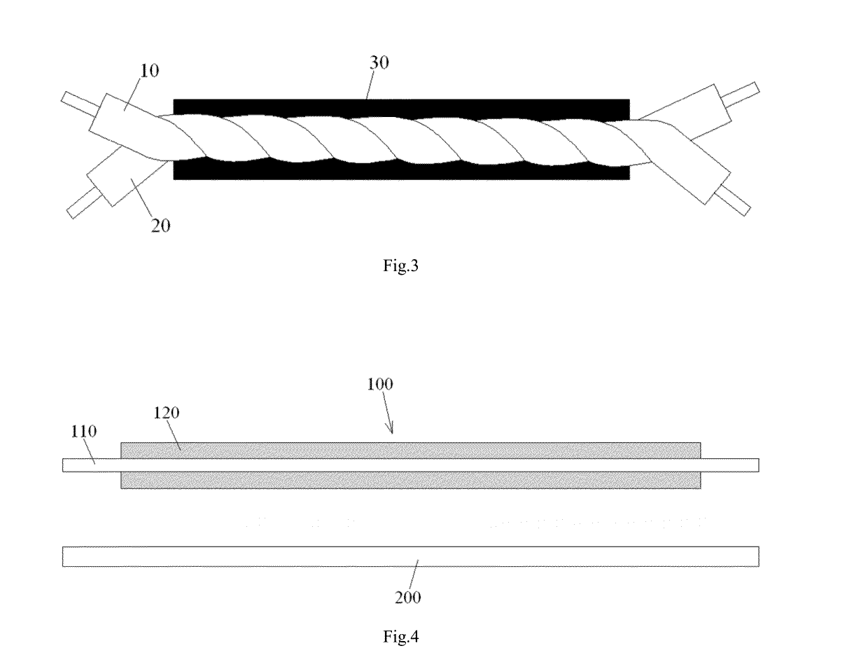

In an embodiment of the invention, as clearly shown in FIG. 3, the cable beam may further include an outer insulation layer 30 clad on the first cable 10 and the second cable 20 wound with each other.

In an embodiment of the invention, the outer insulation layer 30 may be disposed on the first cable 10 and the second cable 20 using extrusion molding.

In an embodiment of the invention, the first PTC material layer 12 is disposed on the first conductor 11 using extrusion molding. Similarly, the second PTC material layer 22 is disposed on the second conductor 21 using extrusion molding.

In an embodiment of the invention, there is also provided a load circuit (not shown) having the cable beam shown in FIG. 3. The cable beam is connected in series on the load circuit to transmit electric power to various electrical equipment (not shown) on the load circuit and provide over current protection for the various electrical equipment.

In the shown embodiments, one of the first conductor 11 and the second conductor 21 of the cable beam is used as a positive electrode and the other is used as a negative electrode. For example, the first conductor 11 of the first cable 10 is electrically connected to an electrode (for example, a negative electrode) of a first equipment on the load circuit, while the second conductor 21 of the second cable 20 is electrically connected to an electrode (for example, a positive electrode) of a second electrical equipment on the load circuit. In this way, the negative electrode of the first electrical equipment is electrically connected to the positive electrode of the second electrical equipment using the cable beam shown in FIG. 3. Specifically, the first electrical equipment and the second electrical equipment are electrically connected in series using the cable beam shown in FIG. 3. During normal use of the load circuit, the current is transmitted between the first conductor 11 and the second conductor 21 of the cable beam.

On one hand, the first and second PTC material layers 12, 22 display very small resistance in low temperatures, which allows a normal current to pass therethrough. Thereby, during normal use, the first and second PTC material layers 12, 22 have small resistance in lower temperatures and the normal current flows between the first and second conductors 11, 21 through the first and second PTC material layers 12, 22, so that the electrical equipment connected with each other using the cable beam may work normally.

On the other hand, the first and second PTC material layers 12, 22 display very large resistance in higher temperatures and limit a current to pass therethrough. Thereby, when excessive current flows through the first conductor 11, the second conductor 21, the first PTC material layer 12 and the second PTC material layer 22, the temperature and the resistance of the first PTC material layer 12 and the second PTC material layer 22 rapidly increases, so that the current through the first and second conductors 11, 21 rapidly decreases below a selected allowable current value, or is even decreased to zero.

Therefore, in the embodiments of the invention, the cable according to the invention not only has a function of power transmission, but also provides over current, over voltage and over thermal protection. Thereby, it may effectively prevent the cables, as well as various electrical equipment connected with the cables, from being burned off due to over current or over heat.

In an embodiment of the invention, the first cable 10 and the second cable 20 may be round, oval, square, 8-shaped or having any other suitable shaped cross section.

In the embodiment shown in FIGS. 1 through 3, the cable beam includes a pair of first and second conductors 11, 21. But the invention is not limited to this and the cable beam may include a plurality of conductors.

Hereafter, a method of manufacturing the cable beam according to the invention will be described with reference to FIGS. 1 through 3.

In an embodiment of the invention, a method of manufacturing the cable beam, generally includes the steps of: (1) providing a first cable 10 having a first conductor 11 and a first PTC material layer 12 clad on the first conductor 11 and a second cable 20 having a second conductor 21 and a second PTC material layer 22 clad on the second conductor 21, as shown in FIGS. 1 and (2) winding the first cable 10 and the second cable 20 with each other, as shown in FIG. 2, so that the first PTC material layer 12 and the second PTC material layer 22 are in electrical contact with each other and a current can flow from the first conductor 11 to the second conductor 21 through the first and second PTC material layers 12, 22.

In an embodiment of the invention, the above method may further include a step of forming an outer insulation layer 30 on the first cable 10 and the second cable 20 wound with each other.

As shown in FIG. 1, in an embodiment of the invention, a method of manufacturing the first cable 10 or the second cable 20 may include a further step of extruding molten PTC material on the first conductor 11 or the second conductor 21 by an extruder, so as to form the first PTC material layer 12 or the second PTC material layer 22 clad on the first conductor 11 or the second conductor 21.

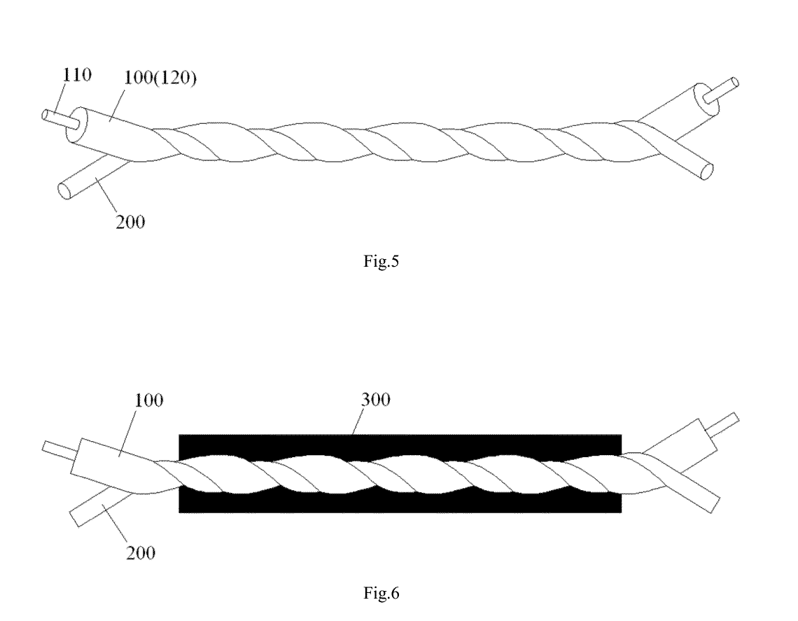

Now with reference to FIGS. 4 through 6, another cable beam according to the invention will be described. The cable beam includes a cable 100 and a second conductor 21, such as a bare wire 200. As clearly shown in FIG. 4, the cable 100 includes a conductor 110 and a PTC (Positive Temperature Coefficient) material layer 120 clad on the conductor 110. In an embodiment of the invention, as clearly shown in FIG. 5, the cable 100 and the bare wire 200 are wound with each other, so that the PTC material layer 120 is in electrical contact with the bare wire 200 and a current is able to flow between the conductor 110 and the bare wire 200 through the PTC material layers 120.

In an embodiment of the invention, as clearly shown in FIG. 6, the cable beam may further include an outer insulation layer 30 clad on the cable 100 and the bare wire 200 wound with each other.

In an embodiment of the invention, an outer insulation layer 300 is disposed on the cable 100 and the bare wire 200 using extrusion molding.

In an embodiment of the invention, the PTC material layer 120 is disposed on the conductor 110 using extrusion molding.

In an embodiment of the invention, the bare wire 200 may be a copper wire, a copper tin wire or any other suitable conductive wire.

In an embodiment of the invention, there is also provided a load circuit (not shown) comprising the cable beam shown in FIG. 6. The cable beam is connected in series on the load circuit to transmit electric power to various electrical equipment (not shown) on the load circuit and provide over current protection for the various electrical equipment.

In the shown embodiment, one of the conductor 110 and the bare wire 200 is used as a positive electrode and the other is used as a negative electrode. For example, the conductor 110 of the cable 100 is electrically connected to an electrode (for example, a negative electrode) of a first equipment on the load circuit; and the bare wire 200 is electrically connected to an electrode (for example, a positive electrode) of a second electrical equipment on the load circuit. In this way, the negative electrode of the first electrical equipment is electrically connected to the positive electrode of the second electrical equipment via the cable beam shown in FIG. 6. Specifically, the first electrical equipment and the second electrical equipment are electrically connected in series using the cable beam shown in FIG. 6. In this case, during normal use of the load circuit, the current is transmitted between the conductor 110 and the bare wire 200 of the cable beam.

On one hand, the PTC material layer 120 displays very small resistance in low temperatures and it may allow a normal current to pass therethrough. Thereby, during normal use, the PTC material layer 120 is in a condition of low temperatures and displays small resistance and the normal current may flow between the conductor 110 and the bare wire 200 through the PTC material layer 120, so that the electrical equipment connected with each other using the cable beam may work normally.

On the other hand, the PTC material layer 120 also displays very large resistance in high temperatures and limits a current to pass therethrough. Thereby, when excessive current flows through the conductor 110, the bare wire 200, and the PTC material layer 120, the temperature and the resistance of the PTC material layer 120 are rapidly increases, so that the current passing through the conductor 110 and the bare wire 200 rapidly decreases below a selected allowable current value, or it is even decreased to zero.

Therefore, in the embodiments of the invention, the cable beam not only functions to transmit power, but also provides over current, over voltage and over thermal protection. Thereby, it may effectively prevent the cable beams as well as various electrical equipment connected with the cable beams from being burned off due to over current or over heat.

In an embodiment of the invention, the cable 100 and the bare wire 200 may have round, oval, square, 8-shaped or any other suitable shaped cross section.

Hereafter, a method of manufacturing the cable beam according to FIGS. 4-6 will be described.

In an embodiment of the invention, a method of manufacturing the cable beam according to the invention generally includes the steps of: (1) providing a cable 100 having a conductor 110 and a PTC material layer 120 clad on the conductor 110 and a bare wire 200, as shown in FIGS. 4 and (2) winding the cable 100 and the bare wire 200 with each other, as shown in FIG. 5, so that the PTC material layer 120 is in electrical contact with the bare wire 200 and a current flows from one of the conductor 110 and the bare wire 200 to the other of the conductor 110 and the bare wire 200 through the PTC material layer 120.

In an embodiment of the invention, the above method may further include a step of forming an outer insulation layer 300 on the cable 100 and the bare wire 200 wound with each other.

As shown in FIG. 4, in an embodiment of the invention, a method of manufacturing the cable 100 may include a further step of extruding molten PTC material on the conductor 110 by an extruder, so as to form the PTC material layer 120 clad on the conductor 110.

In the above various embodiments of the invention, the cable beam is made of PPTC (polymer positive temperature coefficient) material and conductor by using the existing traditional cable processing technology. If necessary, an insulation layer is disposed on the PTC material layer. This cable beam not only has the function of power transmission, but also provides over current, over voltage, and over thermal protection. In this way, the traditional independent circuit protection device and its accessories may be replaced by this cable beam of the invention and the installation space for mounting the independent circuit protection device and its accessories may be saved.

It should be appreciated by those skilled in this art that the above embodiments are intended to be illustrative and not restrictive. For example, many modifications may be made to the above embodiments by those skilled in this art and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A cable beam, comprising:
a first cable having a first conductor and a first PTC material layer clad on the first conductor; and
a second cable having:
(a) a second conductor and a second PTC material layer clad on the second conductor; and
(b) the second cable wound with the first cable such that the first PTC material layer is electrically connected to the second PTC material layer.

2. The cable beam according to claim 1, wherein the first PTC material layer is extruded onto the first conductor.

3. The cable beam according to claim 2, wherein the second PTC material layer is extruded onto the second conductor.

4. The cable beam according to claim 1, further comprising an outer insulation layer clad on the wound first cable and the second cable.

5. A cable beam, comprising:
a cable having a conductor and a PTC material layer clad on the conductor; and
a second conductor wound with the cable and in electrical connection with the PTC material layer.

6. The cable beam according to claim 5, wherein the second conductor is a bare wire.

7. The cable beam according to claim 6, further comprising an outer insulation layer clad on the wound cable and the bare wire.

8. A method of manufacturing a cable beam, comprising steps of:
providing a first cable having a first conductor and a first PTC material layer clad on the first conductor;
providing a second cable having a second conductor and a second PTC material layer clad on the second conductor; and
winding the first cable and the second cable with each other such that the first PTC material layer and the second PTC material layer are in electrical contact with each other.

9. The method according to claim 8, wherein the first PTC material layer is extruded onto the first conductor.

10. The method according to claim 9, wherein the second PTC material layer is extruded onto the second conductor.

11. The method according to claim 8, further comprising step of disposing an outer insulation layer on a winding of the first cable and the second cable.
